(19) United States
(12) Patent Application Publication
(10) Pub. No.: US 2026/0237917 A1
(43) Pub. Date: Aug. 13, 2026

(54) ELECTRICAL CONNECTORS WITH SCREW-TERMINATED CONTACTS

(71) Applicant: IDEAL Industries, Inc., Sycamore, IL (US)

(72) Inventor: Anna Gadecki, Leominster, MA (US)

(21) Appl. No.: 19/149,614

(22) PCT Filed: Jan. 24, 2023
(86) PCT No.: PCT/US2023/061137

§ 371 Date: Jul. 21, 2025

(51) Int. Cl. H01R 4/34; H01R 43/20

(52) U.S. Cl. CPC H01R 4/34; H01R 43/20

(57) ABSTRACT

An example electrical connector has a contact, an inner housing, a terminal, and a screw. The contact has a plate portion defining a contact hole and a contact portion extending from the plate portion. The inner housing has a slot shaped to receive the plate portion and to hold the contact in a substantially fixed position. The terminal is movably positioned within the inner housing, and has a contact surface and a threaded hole. The screw is sized to be received by the contact hole and to interface with the threaded hole. Rotating the screw causes the terminal to move relative to the plate portion of the contact and to compress a wire between the plate portion of the contact and the terminal.

### TECHNICAL FIELD

This disclosure generally relates to electrical connectors, including electrical connectors that secure wires in place with screws.

### BRIEF DESCRIPTION OF THE DRAWINGS

FIG. 1 is a front perspective view of an example electrical connector plug.

FIG. 2 is a front view of the example electrical connector plug of FIG. 1.

FIG. 3 is a front view of the example electrical connector plug of FIG. 1 without an inner housing.

FIG. 4 is a perspective view of a connector shell of the example electrical connector plug of FIG. 1.

FIG. 5 is a top view of the example electrical connector plug of FIG. 1.

FIG. 6 is a left view of the example electrical connector plug of FIG. 1.

FIG. 7A is a perspective view of an upper clamp of the example electrical connector plug of FIG. 1.

FIG. 7B is a top view of the upper clamp of FIG. 7A.

FIG. 7C is a perspective view of a lower clamp of the example electrical connector plug of FIG. 1.

FIG. 8 is a front perspective view of an inner housing of the example electrical connector plug.

FIG. 9 is a perspective view of the inner housing of FIG. 8 without terminals, contacts, and screws.

FIG. 10 is a front view of the inner housing of FIG. 8.

FIG. 11 is a section view of the inner housing of FIG. 8, taken along the line 11-11 in FIG. 10.

FIG. 12 is a front view of the inner housing of FIG. 8 without terminals, contacts, and screws.

FIG. 13 is a perspective view of a contact of the example electrical connector plug of FIG. 1.

FIG. 14 is an exploded view of the example electrical connector plug of FIG. 1.

FIG. 15 is a flow chart of an example method for assembling a connector assembly.

### DETAILED DESCRIPTION

A novel electrical connector according to the present disclosure may enable wires or cables to be secured within the connector via screws, which removes the need for crimping or over-molding. Not only does this reduce the risk of damage to the inserted wires or cables, but this also enables a user to couple a cable to the connector without specialized equipment. As such, the connector may be freely swapped out (or the cable coupled to the connector) while a user is out in the field and on a job-site. Furthermore, these screw-based tightening mechanisms enable a wider range of cables and/or wires to be compatible with the connector.

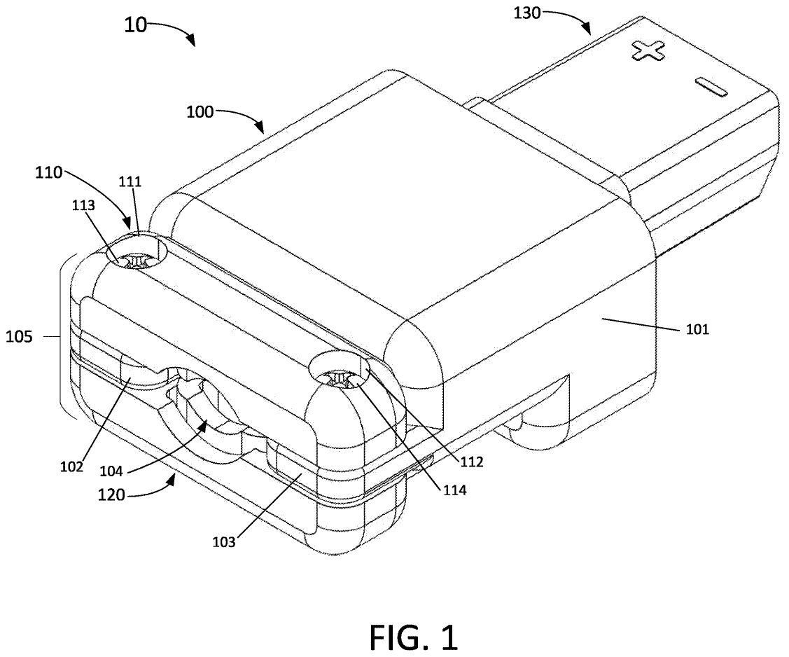

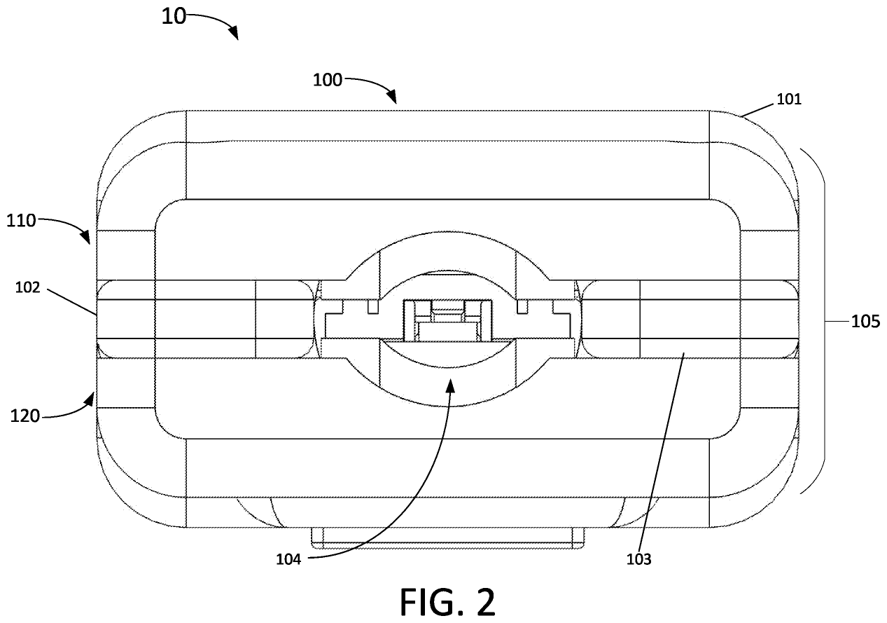

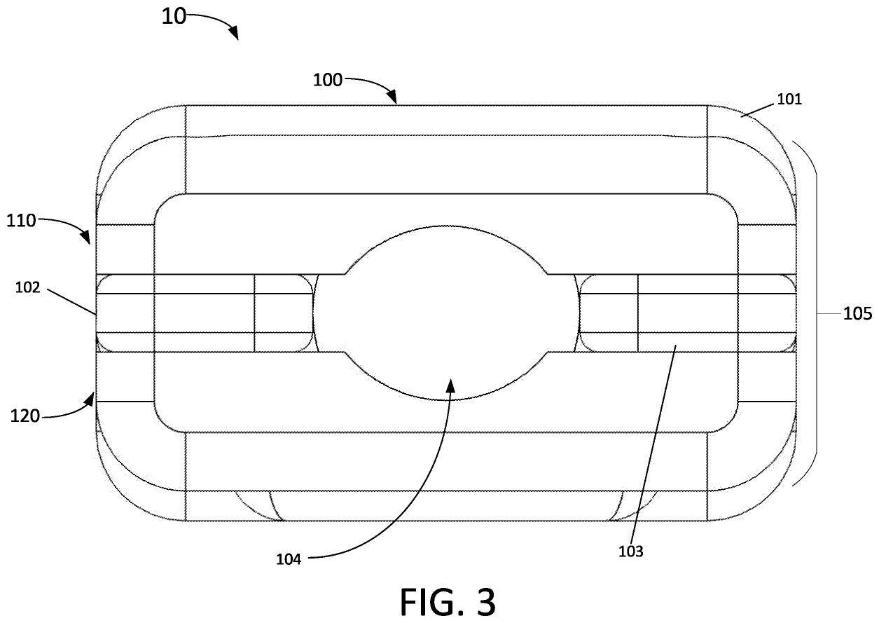

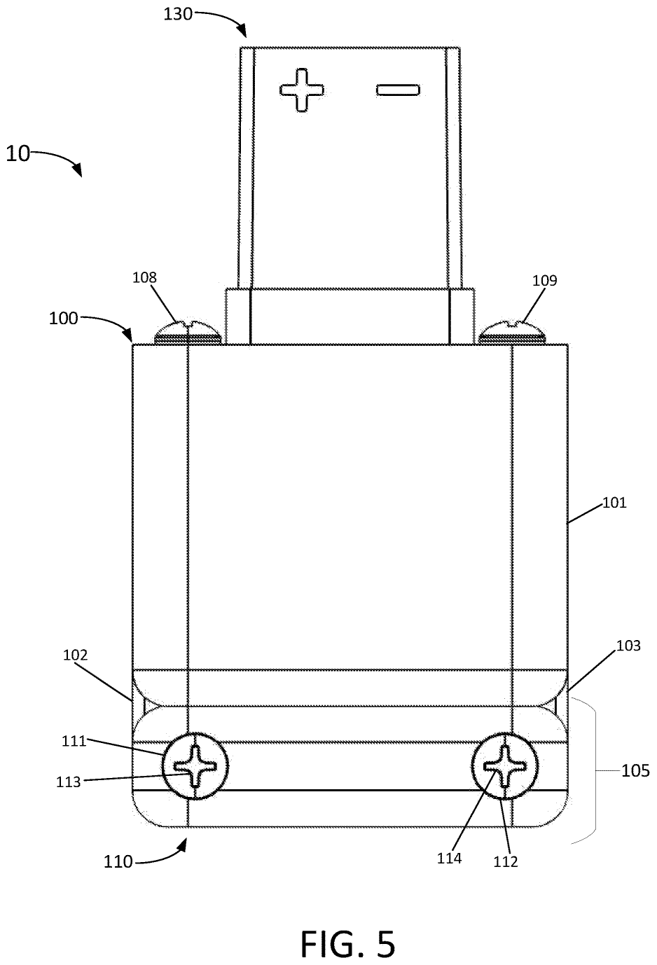

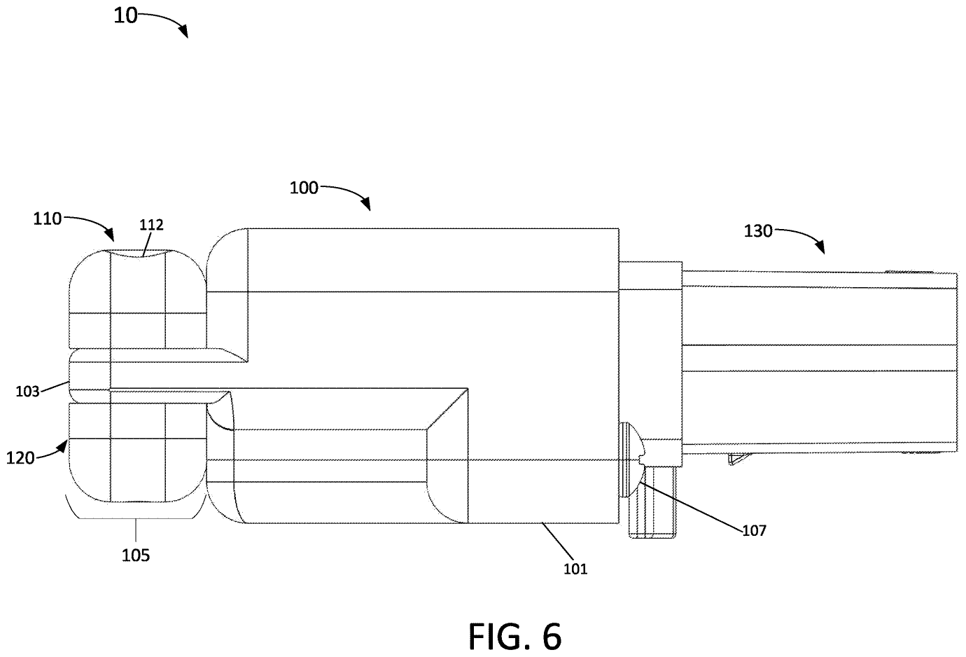

Referring now to the drawings, wherein like numerals refer to the same or similar features in the various views, FIGS. 1-6 illustrate an example electrical connector plug 10.

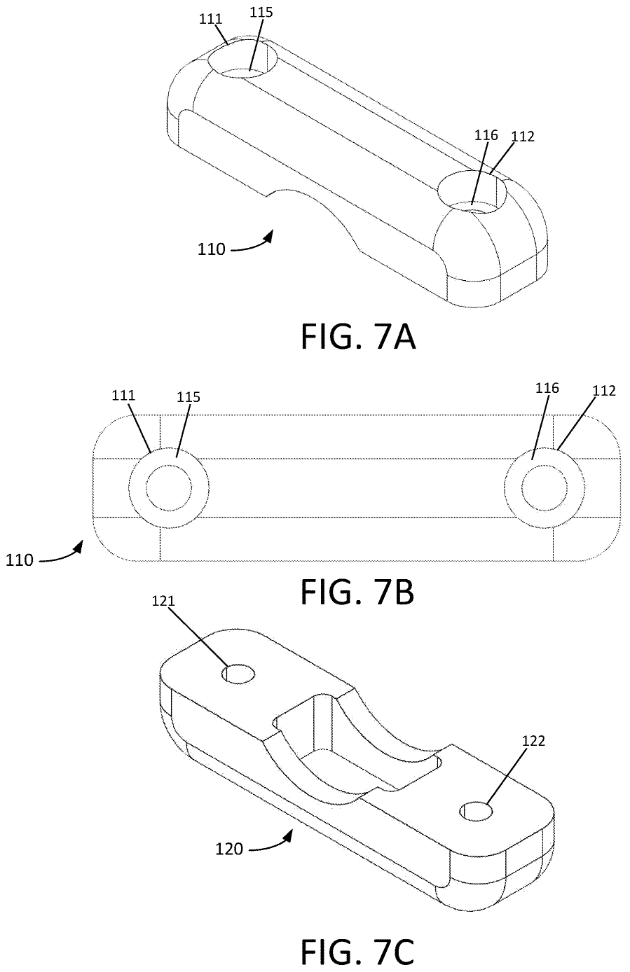

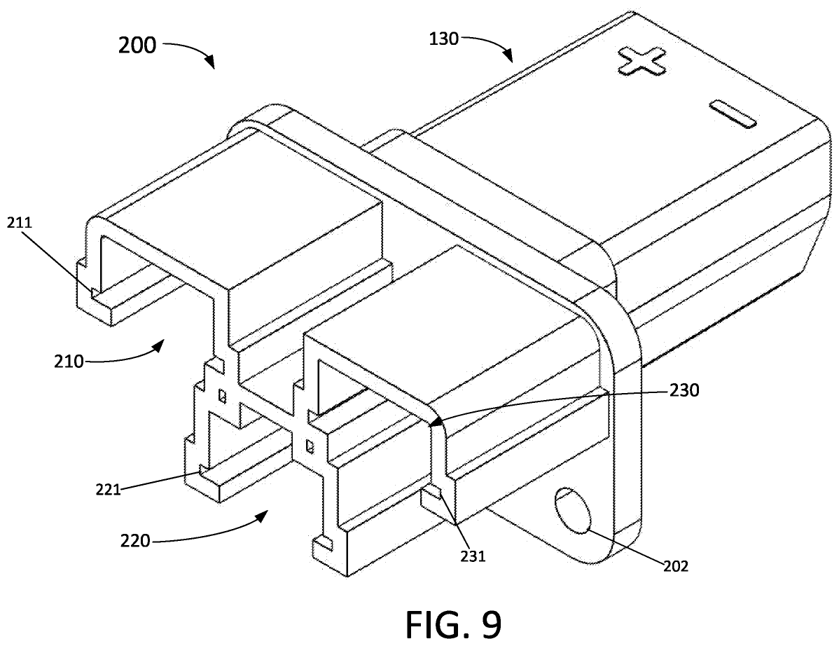

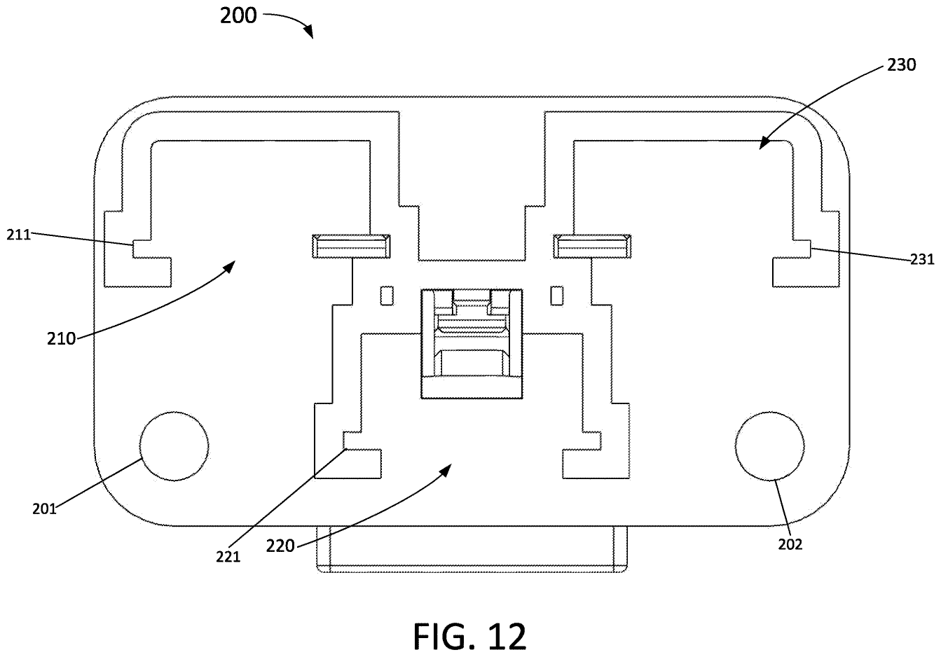

The connector plug 10 may include a shell 100, a clamp 105, and a plug portion 130. The shell 100 may be structured to surround and protect an inner housing 200, which is described in greater depth below with reference to FIGS. 7-14. The shell 100 may be removably secured to the inner housing 200 via first housing screw 108 and second housing screw 109. Clamp 105 may be positioned about a rear (e.g., relative to the direction in which the connector plug 10 may mate with another connector) opening of the shell 110 and include an upper clamp portion 110 and a lower clamp portion 120, as well as a first spacer 102 and a second spacer 103 of the shell 100. The first spacer 102 and the second spacer 103 may collectively define aperture 104. The plug portion 130 may extend in a forward direction away from the shell 100 and be configured to mate with another connector. In operation, one or more electrical wires or cables may extend through the aperture 104 to the inner housing 200, and each may be electrically coupled with a respective electrical contact(s) of the inner housing 200. Once the wire or cable is inserted into the aperture 104, the clamp 105 may be tightened around the wire or cable by tightening a first clamp screw 113 and a second clamp screw 114, which may be positioned on either side of the aperture 104. The electrical wires or cables connected to the respective electrical contact(s) in the inner housing 200 may further extend beyond the connector plug 10 for connection to electrical signals sources or destinations (e.g., via the plug portion 130 mating with a respective receptacle). Although the first clamp screw 113 and the second clamp screw 114 (as well as other screws in this disclosure) are referred to as screws, each may be any suitable threaded member (e.g., bolt), such that the disclosure should not be read as limited to only screws.

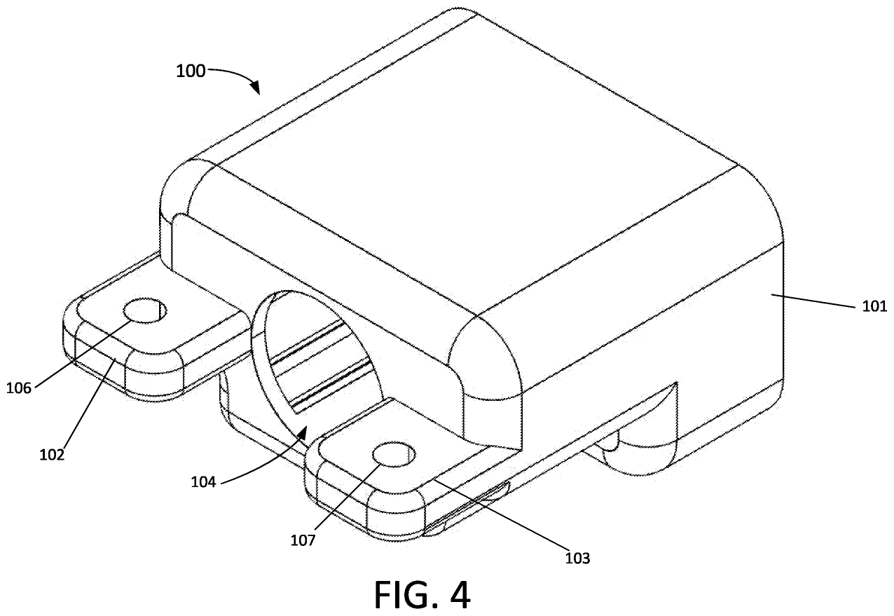

As shown in FIG. 4, which is a perspective view of the shell 100, the shell 100 may include a body 101, and the first spacer 102 and the second spacer 103 may extend in a relatively rearward direction from the body 101. The first spacer 102 and the second spacer 103 may be positioned on either lateral side of the aperture 104, such that inner sides of the first spacer 102 and the second spacer 103 each define a portion of the aperture 104. In other embodiments, the first spacer 102 and the second spacer may be positioned on either vertical side of the aperture 104. The first spacer 102 may include a first spacer passageway 106 that may be sized to receive the first clamp screw 113. Similarly, the second spacer 103 may include a second spacer passageway 106 that may be sized to receive the second clamp screw. Each of the first spacer 102 and the second spacer 103 may be monolithically formed with the body 101, such that the shell 100 comprises a monolithic and continuous structure that may be molded (e.g., injection molded) as a single component.

Referring now to FIGS. 7A-C, the upper clamp portion 110 and the lower clamp portion 120 are shown in isolation. The upper clamp portion 110 may include a first upper clamp passageway 111 and a second upper clamp passageway 112, each of which is sized to receive the first clamp screw 113 and the second clamp screw 114. In some embodiments, the upper clamp passageway 111 and the second upper clamp passageway 112 may be threaded to directly interface with the first clamp screw 113 and the second clamp screw 114, while in other embodiments, the upper clamp passageway 111 and the second upper clamp passageway 112 may be relatively smooth to allow the first clamp screw 113 and the second clamp screw 114 to pass through without direct interfacing. In some embodiments, the upper clamp passageway 111 and the second upper clamp passageway 112 may each include a first lip 115 and a second lip 116 respectively that may each interface with a head of the first clamp screw 113 or second clamp screw 114, such that the threaded portion of the first clamp screw 113 and the second clamp screw 114 may pass entirely through the upper clamp passageway 111 and the second upper clamp passageway 112 but that the relatively-larger head would abut the first lip 115 or the second lip 116. The first lip 115 and the second lip 116 may be an isolated portion of material that causes the upper clamp passageway 111 and the second upper clamp passageway 112 to have a relatively smaller diameter for the length of the isolated portion, or the first lip 115 and the second lip 116 may be formed as a transition within the upper clamp passageway 111 and the second upper clamp passageway 112 from a first, larger diameter to a second, smaller diameter. The lip 115, 116 may be or may include an annular surface that protrudes inward from the sidewall of the upper clamp passageway 111, 112 and that is generally perpendicular to the direction of movement of the clamp screw 113, 114 into and out of the upper clamp passageway 111, 112.

Similarly, the lower clamp portion 120 may include a first lower clamp passageway 121 and a second lower clamp passageway 122, each of which is sized to receive the first clamp screw 113 and the second clamp screw 114. In some embodiments, the lower clamp passageway 121 and the second lower clamp passageway 122 may be threaded to directly engage and interface with threads of the first clamp screw 113 and the second clamp screw 114.

In use, the upper clamp portion 110 may be positioned on a relative top of the first spacer 102 and of the second spacer 103, such that the first upper clamp passageway 111 aligns with the first spacer passageway 106 and the second upper clamp passageway 112 aligns with the second spacer passageway 107. The lower clamp portion 120 may be positioned on a relative bottom of the first spacer 102 and of the second spacer 103, such that the first lower clamp passageway 121 aligns with the first spacer passageway 106 and the second lower clamp passageway 122 aligns with the second spacer passageway 107. When the upper clamp portion 110 and the lower clamp portion 120 are both in position on either side of the first spacer 102 and the second spacer 103, the first upper passageway 111, the first spacer passageway 106, and the first lower passageway 121 may collectively form a first passageway, and the second upper passageway 112, the second spacer passageway 107, and the second lower passageway 123 collectively form a second passageway.

The first clamp screw 113 may be inserted into this collectively-formed first passageway, and the second clamp screw 114 may be inserted into this collectively-formed second passageway. In the embodiment shown in FIG. 1, the first clamp screw 113 and the second clamp screw 114 are inserted first through the upper clamp portion 110, such that the heads of the first clamp screw 113 and of the second clamp screw 114 may be exposed from the upper clamp portion 110. By turning at least one of the first clamp screw 113 or the second clamp screw 114 in a tightening direction, the upper clamp portion 110 and the lower clamp portion 120 may be drawn towards each other to reduce an effective size (e.g., diameter and/or circumference) of the aperture 104. For example, turning the first clamp screw 113 causes the first clamp screw 113 to move longitudinally along an axis defined by a length of the first clamp screw 113 due to the threaded interface with at least the first lower passageway 121. By turning the first clamp screw 113 in a tightening direction (e.g., clock-wise rotation), the first clamp screw 113 may be caused to move relatively downwards, which, in turn, may cause the head of the first clamp screw 113 to abut the first lip 115 of the first upper passageway 111. Further downward movement of the first clamp screw 113 may be transferred, via the abutment of the head, to the upper clamp portion 110, which may cause the upper clamp portion 110 to move similarly downward (e.g., towards the first spacer 102 and second spacer 103). If the upper clamp portion 110 is unable to move further downward (e.g., because the upper clamp portion 110 abuts the first spacer 102 and second spacer 103, because the upper clamp portion 110 abuts the inserted wire, etc.), the interfacing of the first clamp screw 113 may instead cause the lower clamp portion 120 to move relatively upwards (e.g., towards the first spacer 102 and second spacer 103, towards an inserted wire, etc.). Because the size of the aperture 104 may be adjustable via the upper clamp portion 110 and the lower clamp portion 120, the example electrical connector plug 10 may be configured to receive cables (or wires) of varying sizes. In the example embodiment shown, the aperture 104 may be sized to receive wires ranging from 18 gauge (e.g., approximately 1.024 mm diameter) to 10 gauge (e.g., approximately 2.588 mm diameter).

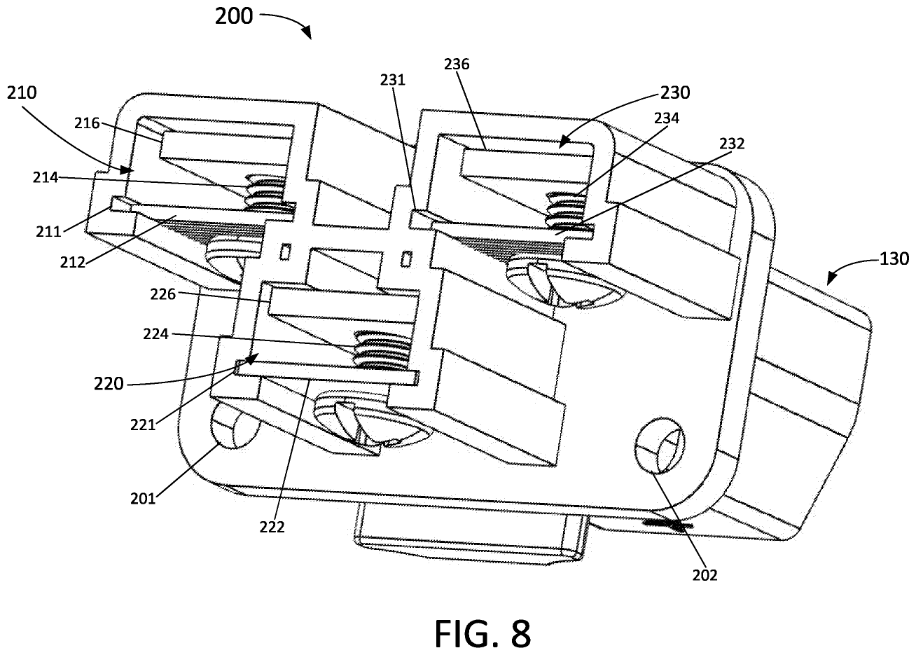

Referring now to FIGS. 8-13, the inner housing 200 may include a first chamber 210, a second chamber 220, and a third chamber 230. Each chamber may be structured to receive a wire (e.g., from the inserted cable, or as separately-inserted wires). For example, a live wire (e.g., a wire carrying a signal from an origin) may be inserted into the first chamber 210, and a ground wire may be inserted into the second chamber 220. The inner housing 200 may also be structured to establish and maintain a minimum distance between wire contacts (e.g., to avoid arcing between contacts). In the example embodiment shown, the minimum distance between each wire contact (e.g., a wire contact in the first chamber 210 and a wire contact in the second chamber 220, etc.) may be 7 mm. In other embodiments, the minimum distance between each wire contact may be 6 mm. Although the inner housing 200 shown includes only three chambers, an inner housing 200 having fewer or more chambers are within the scope of this disclosure, such that this disclosure should not be read as limited to three-chambered inner housings 200. Instead, an inner housing according to the present disclosure may instead have two chambers, four chambers, or any other number of chambers as appropriate for a given application. The inner housing 200 may also include a first housing hole 201 and a second housing hole 202 sized to receive the first housing screw 108 and the second housing screw 109 to couple the shell 100 to the inner housing 200.

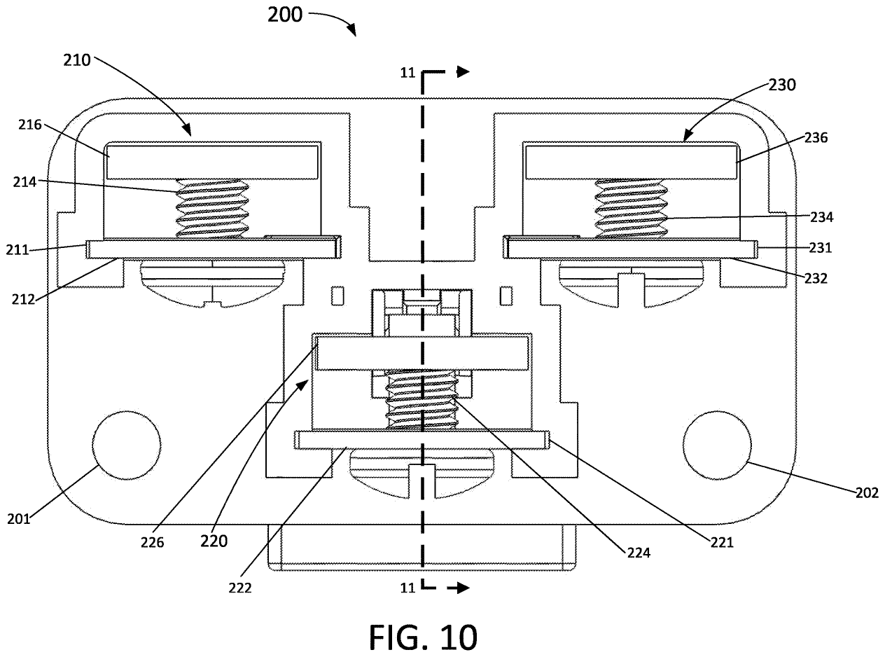

The first chamber 210 may include a first slot 211, a first contact 212, a first chamber screw 214, and a first terminal 216. The first slot 211 may be shaped to receive the first contact 212 and to hold the first contact 212 in a substantially fixed position, relative to an axis defined by a length of the first chamber screw 214. The first contact 212 may include a hole (e.g., an analogous hole to a contact hole 229, described below) shaped to receive the first chamber screw 214. After passing through the first contact 212, the first chamber screw 214 may interface with a hole in the first terminal plate 216. This hole may be threaded, such that the first chamber screw 214 may directly interface with the first terminal plate 216. In operation, a wire may be inserted in the space between the first terminal 216 and the first contact 212. Once the wire is in place, the first chamber screw 212 may be turned in a tightening direction (e.g., clock-wise), which may cause the first chamber screw 212 to move in an upward direction (relative to the orientation shown in FIG. 8). Because the first contact 212 is in a substantially fixed position (relative to the movement of the first chamber screw 214), the first chamber screw 214 may be prevented from further longitudinal movement by the first contact 212, which may cause the rotational force to be transferred to the first terminal 216 via the interfacing of the hole of the first terminal 216 with the threads of the first chamber screw 214. As shown in FIG. 10, the shape and size of the first chamber 210 may be such that the first terminal plate 216 abuts or nearly abuts the walls of the first chamber 210, which prevent the first terminal plate 216 from rotating within the first chamber 210. As such, when the rotational force of the first chamber screw 214 is transferred to the first terminal plate 216, the first terminal plate 216 moves longitudinally within the first chamber 210 because the first terminal plate 216 cannot rotate. Due to the threading, when the first chamber screw 214 is turned in a tightening direction, the first terminal plate 216 may move longitudinally downwards (relative to the view shown in FIG. 10), such that the first terminal plate 216 may be drawn towards the first contact 212, thereby compressing the inserted wire.

A size (e.g., diameter, length, threading, etc.) of the first chamber screw 214 may be based on a gauge of the inserted wire, with larger wires requiring larger screw sizes. Because the aperture 104 may receive cables up to 10 gauge, the first chamber screw 214 may be large enough to hold wires contained within 10 gauge cables. Accordingly, the inner housing 200 may be structured to accommodate screws (e.g., the first chamber screw 214) of adequate size.

The second chamber 220 and the third chamber 230 may be substantially identical to the first chamber 210, such that each includes analogous components and functions in a substantially identical manner. As shown, the second chamber 220 may include a second slot 221 analogous to the first slot 211, a second contact 222 analogous to the first contact, a second chamber screw 224 analogous to the first chamber screw 214, and a second terminal 226 analogous to the first terminal 216. Similarly, the third chamber 230 may include a third slot 231 analogous to the first slot 211, a third contact 232 analogous to the first contact, a third chamber screw 234 analogous to the first chamber screw 214, and a third terminal 236 analogous to the first terminal 216.

As described above, the inner housing 200 may include any number of chambers, as well as any configuration of chambers. In the example embodiment shown, the inner housing 200 has three chambers (e.g., 210, 220, and 230), and may receive three wires-two live wires and one ground wire. For example, a first live wire may be inserted into the first chamber 210, a second live wire may be inserted into the third chamber 230, and a ground wire may be inserted into the second chamber 220.

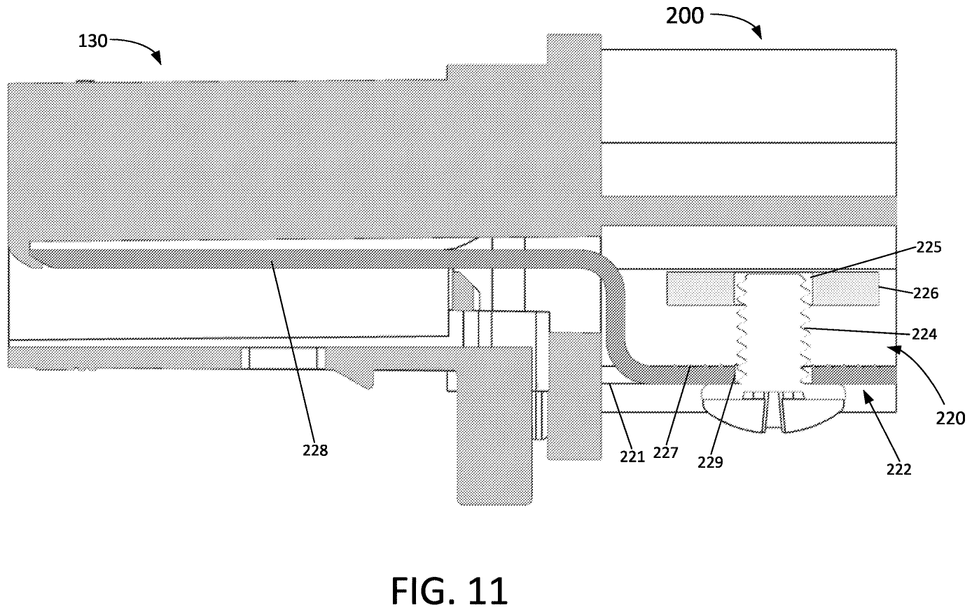

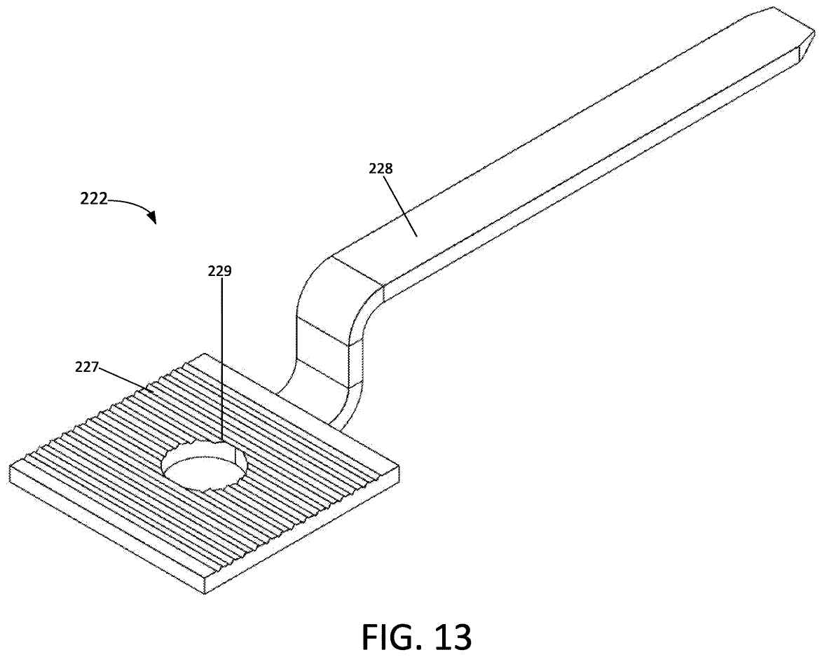

Referring now to FIG. 13, the second contact 222 is shown in isolation. The second contact 222 may include a contact plate 227, a contact extension 228, and a contact hole 229. The contact plate 227 may be configured to receive an electrical current or signal from an exposed wire (e.g., the live or ground wire inserted into the second chamber 220). In some embodiments, the contact plate 227 may be textured (e.g., ribbed) to increase an amount of surface area of the contact plate 227, which may increase a quality of contact (e.g., consistency of connection, lack of signal loss, etc.) with the exposed wire. The contact extension 228 may be monolithically formed with and extend away from the contact plate 227, such that the contact extension 228 may be configured to carry the current that passed from the exposed wire to the contact plate 227 further to a point away from the exposed wire. As shown in FIG. 11, which is a cross-sectional view taken along the line 11-11 of FIG. 10, the contact extension 228 may extend from the second chamber 220 of the inner housing 200 into the plug portion 130, where the contact extension 228 may be exposed to and may be electrically coupled with a respective contact of a receptacle mated with the connector plug 10. As described above with reference to the first contact 212, the contact hole 229 may be sized to receive the second chamber screw 224. In some embodiments, the contact hole 229 may be unthreaded to allow free rotation of the second chamber screw 224 within the contact hole, while in other embodiments, the contact hole 229 may be threaded to facilitate rotation of the second chamber screw 224.

As shown, the second contact 222 may feature a curved portion, such that the contact extension 228 may be on a different horizontal plane than the contact plate 227. Because the inner housing 200 may be structured to maintain a minimum distance between contacts (e.g., the contacts 212, 222, 232) but the mating face of the connector plug 10 may be required to have relatively closer contact points (e.g., based on the configuration of the mating face), the curved portion of the second contact 222 may enable the minimum distance to be maintained on one end of the connector plug 10 without impeding or restricting available mating face configurations. Accordingly, the rear (e.g., relative to the direction in which the connector plug 10 may mate with another connector) of the connector plug 10 may be larger than a front of the connector plug 10. For example, the rear of the connector plug 10 may have a larger surface area than the mating front of the connector plug, and the rear may have a larger diameter (e.g., perpendicular to a central axis defined by the direction of mating) than that of the mating front. A transition from the larger rear to the smaller front may be a vertical face, or may be a curved or similar intermediate transition. The curved portion of the second contact 222 may be contained within the transition, such that the curved portion of the second contact 222 may define a portion of the transition.

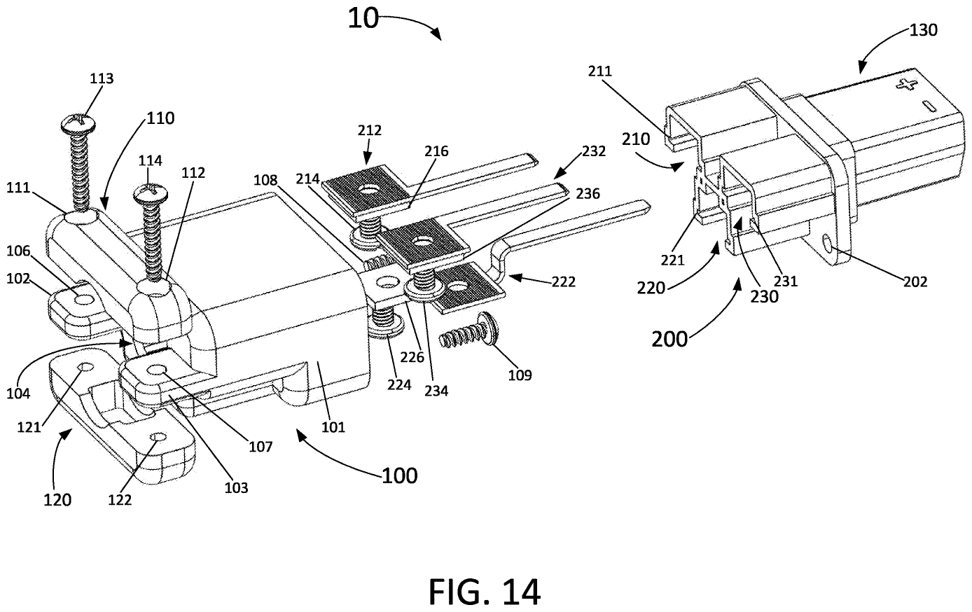

Referring now to FIG. 14, which shows an exploded view of the connector plug 10, the first contact 212 and third contact 232 may be shaped differently from the second contact 222. Regardless of the specific configuration of components, each of the first contact 212 and third contact 232 may include components analogous to the contact surface 227, the contact extension 228, and the contact hole 229 of the second contact.

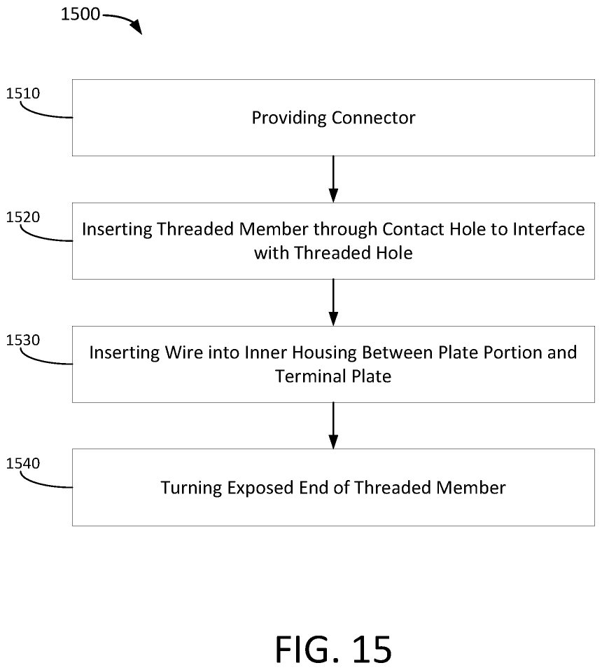

FIG. 15 is a flow chart illustrating an example method 1500 for assembling a connector assembly. The method 1500, or one or more portions of the method 1500, may include the plug assembly 10 (e.g. creating an assembly including the plug assembly 10), in some embodiments.

The method 1500 may include, at block 1510, providing a connector. This connector may be the plug assembly 10, and may include any or all of the components of the plug assembly 10 described above. For example, providing the connector may involve providing a contact (e.g., second contact 222), an inner housing (e.g., inner housing 200), and a terminal plate (e.g., second terminal 226). The contact may include a plate portion (e.g., contact plate 227) having a contact hole (e.g., contact hole 229) and a contact portion (e.g., contact extension 228) extending from the plate portion. The inner housing may define a slot (e.g., second slot 221) shaped to receive the plate portion and to hold the contact in a substantially fixed position. The terminal plate may be movably positioned within the inner housing, and may include a terminal surface and a threaded hole.

The method 1500 may also include, at block 1520, inserting a threaded member through the contact hole to interface with the threaded hole of the terminal plate, and, at block 1530, inserting a wire into the inner housing between the plate portion and the terminal surface.

The method 1500 may further include, at block 1540, turning an exposed end of the threaded member, which may cause the terminal surface to compress the inserted wire onto the plate portion.

The connector plug 10 of the present disclosure provides many advantages over current electrical connectors. First, because the wires and cable inserted into the connector plug 10 may be secured in place via screws, there is no crimping or over-molding required.

Not only does this reduce the risk of damage to the inserted wires and cable, but this also enables a user to couple a cable to the connector plug 10 without specialized equipment. As such, the connector plug 10 may be freely swapped out (or the cable coupled to the connector plug 10) while a user is out in the field and on a job-site. Second, the screw-based tightening mechanisms, such as those of the clamp 105 and those within the inner housing 200, enable a wider range of cables and/or wires to be compatible with the connector plug 10.

In some embodiments of the present disclosure, an electrical connector may include a contact, an inner housing, a terminal, and a screw. The contact may include plate portion defining a contact hole; and a contact portion extending from the plate portion. The inner housing may include a slot shaped to receive the plate portion and to hold the contact in a substantially fixed position. The terminal may be movably positioned within the inner housing, and may include a contact surface; and a threaded hole. The screw may be sized to be received by the contact hole and to interface with the threaded hole. Rotating the screw causes the terminal to move relative to the plate portion of the contact and to compress a wire between the plate portion of the contact and the terminal.

In some of these embodiments, the inner housing may be shaped to prevent lateral and rotational movement of the terminal relative to an axis defined by the screw.

In some of these embodiments, the inner housing further may include a first end and a second end opposite the first end. The first end may be configured to receive the wire, and the second end may be configured to receive a second electrical connector. In some of these embodiments, the electrical connector may include a connector shell shaped to fit about the first end and prevent access to the exposed end of the screw. In some of these embodiments, the connector shell may be coupled to the inner housing via a second screw.

In other of these embodiments, the connector shell further may include an opening defined by the shell and configured to receive the wire; and a clamp disposed about the opening. In some of these embodiments, the clamp may include an upper clamp portion defining a first upper passageway and a second upper passageway; a lower clamp portion defining a first lower passageway and a second lower passageway; a first spacer body positioned between the upper clamp portion and the lower clamp portion, the first spacer body defining a first spacer passageway aligned with the first upper passageway and the first lower passageway; a second spacer body positioned between the upper clamp portion and the lower clamp portion, the second spacer body defining a second spacer passageway aligned with the second upper passageway and the second lower passageway; a first clamp screw received by the first spacer passageway, the first upper passageway, and the first lower passageway; and a second clamp screw received by the second spacer passageway, the second upper passageway, and the second lower passageway. Turning each of the first clamp screw and the second clamp screw may cause the upper clamp portion and the lower clamp portion to move towards the first spacer body and towards the second spacer body and to compress the wire.

In some of these embodiments, the first spacer body and the second spacer body are monolithically formed with the connector shell.

In some embodiments, an electrical connector may include an inner housing that may include a first end having a first chamber and a second chamber; and a second end configured to receive a mating electrical connector. The electrical connector may also include a first contact having a first plate portion positioned in the first chamber and a first contact extension positioned in the second end of the inner housing; a second contact having a second plate portion positioned in the second chamber and a second contact extension positioned in the second end of the inner housing; a first terminal plate positioned in the first chamber; a second terminal plate positioned in the second chamber; a first screw configured to be received by the first chamber and the first plate portion and to interface with the first terminal plate; a second screw configured to be received by the second chamber and the second plate portion and to interface with the second terminal plate; and a cable inserted into the first end of the inner housing, the cable comprising a live wire positioned in the first chamber and a ground wire positioned in the second chamber. Turning the first screw causes the first terminal plate to compress the live wire into the first plate portion, and turning the second screw causes the second terminal plate to compress the ground wire into the second plate portion.

In some of these embodiments, the first chamber may be shaped to prevent lateral and rotational movement of the first terminal plate relative to a first axis defined by the first screw, and the second chamber may be shaped to prevent lateral and rotational movement of the second terminal plate relative to a second axis defined by the second screw.

In some of these embodiments, the electrical connector may further include a connector shell shaped to fit about the first end and to prevent access to the first and second screws. In some of these embodiments, the connector shell further may include an opening configured to receive the cable; and a clamp disposed about the opening.

In some of these embodiments, the clamp may include an upper clamp portion having a first upper passageway and a second upper passageway; a lower clamp portion having a first lower passageway and a second lower passageway; a first spacer positioned between the upper clamp portion and the lower clamp portion, the first spacer having a first spacer passageway aligned with the first upper passageway and the first lower passageway; a second spacer positioned between the upper clamp portion and the lower clamp portion, the second spacer comprising a second spacer passageway aligned with the second upper passageway and the second lower passageway; a first clamp screw received by the first spacer passageway, the first upper passageway, and the first lower passageway; and a second clamp screw received by the second spacer passageway, the second upper passageway, and the second lower passageway. Turning each of the first clamp screw and the second clamp screw may cause the upper clamp portion and the lower clamp portion to move towards the first spacer and towards the second spacer and to compress the cable.

In some of these embodiments, the first spacer and the second spacer are monolithically formed with the connector shell.

In some embodiments, a method for assembling a connector assembly includes providing a connector that may include a contact, an inner housing, and a terminal plate. The contact may include a plate portion comprising a contact hole; and a contact portion extending from the plate portion. The inner housing may define a slot shaped to receive the plate portion and to hold the contact in a substantially fixed position. The terminal plate may be movably positioned within the inner housing, and may include a a terminal surface; and a threaded hole. The method may also include inserting a threaded member through the contact hole to interface with the threaded hole; inserting the wire into the inner housing between the plate portion and the terminal surface; and turning an exposed end of the threaded member to cause the terminal surface to compress the wire onto the plate portion.

In some of these embodiments, the connector further may include a connector shell shaped to fit about the inner housing and prevent access to the threaded member.

In some of these embodiments, the method further includes coupling the connector shell to the inner housing with a second threaded member.

In some of these embodiments, the connector further may include a clamp that may include an opening shaped to provide access to the inner housing for the wire; an upper clamp portion defining an upper side of the opening; a lower clamp portion defining a lower side of the opening; a first spacer positioned between the upper clamp portion and the lower clamp portion, the first spacer defining a left side of the opening; and a second spacer positioned between the upper clamp portion and the lower clamp portion, the second spacer defining a right side of the opening. In these embodiments, the method further may include inserting a first clamp threaded member into the upper clamp portion, the first spacer, and the lower clamp portion, inserting a second clamp threaded member into the upper clamp portion, the second spacer, and the lower clamp portion, and causing the upper and lower clamp portions to compress the wire by turning each of the first clamp threaded member and the second clamp threaded portion.

In some of these embodiments, the first spacer and the second spacer are monolithically formed with the connector shell.

In some of these embodiments, the inner housing may be further shaped to prevent lateral and rotational movement of the terminal plate relative to an axis defined by the threaded member.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

What is claimed is:

1. An electrical connector comprising:
a contact comprising:
a plate portion defining a contact hole; and
a contact portion extending from the plate portion;
an inner housing comprising a slot shaped to receive the plate portion and to hold the contact in a substantially fixed position;
a terminal movably positioned within the inner housing, the terminal comprising:
a contact surface; and
a threaded hole; and
a screw sized to be received by the contact hole and to interface with the threaded hole,
wherein rotating the screw causes the terminal to move relative to the plate portion of the contact and to compress a wire between the plate portion of the contact and the terminal.

2. The electrical connector of claim 1, wherein the inner housing is shaped to prevent lateral and rotational movement of the terminal relative to an axis defined by the screw.

3. The electrical connector of claim 1, wherein
the inner housing further comprises a first end and a second end opposite the first end,
the first end is configured to receive the wire, and
the second end is configured to receive a second electrical connector.

4. The electrical connector of claim 3, further comprising a connector shell shaped to fit about the first end and prevent access to the exposed end of the screw.

5. The electrical connector of claim 4, wherein the connector shell is coupled to the inner housing via a second screw.

6. The electrical connector of claim 4, wherein the connector shell further comprises:
an opening defined by the shell, the opening configured to receive the wire; and
a clamp disposed about the opening.

7. The electrical connector of claim 6, wherein the clamp comprises:
an upper clamp portion defining a first upper passageway and a second upper passageway;
a lower clamp portion defining a first lower passageway and a second lower passageway;
a first spacer body positioned between the upper clamp portion and the lower clamp portion, the first spacer body defining a first spacer passageway aligned with the first upper passageway and the first lower passageway;
a second spacer body positioned between the upper clamp portion and the lower clamp portion, the second spacer body defining a second spacer passageway aligned with the second upper passageway and the second lower passageway;
a first clamp screw received by the first spacer passageway, the first upper passageway, and the first lower passageway; and
a second clamp screw received by the second spacer passageway, the second upper passageway, and the second lower passageway,
wherein turning each of the first clamp screw and the second clamp screw causes the upper clamp portion and the lower clamp portion to move towards the first spacer body and towards the second spacer body and to compress the wire.

8. The electrical connector of claim 7, wherein the first spacer body and the second spacer body are monolithically formed with the connector shell.

9. An electrical connector comprising:
an inner housing comprising:
a first end having a first chamber and a second chamber; and
a second end configured to receive a mating electrical connector;
a first contact having a first plate portion positioned in the first chamber and a first contact extension positioned in the second end of the inner housing;
a second contact having a second plate portion positioned in the second chamber and
a second contact extension positioned in the second end of the inner housing;
a first terminal plate positioned in the first chamber;
a second terminal plate positioned in the second chamber;
a first screw configured to be received by the first chamber and the first plate portion and to interface with the first terminal plate;
a second screw configured to be received by the second chamber and the second plate portion and to interface with the second terminal plate; and
a cable inserted into the first end of the inner housing, the cable comprising a live wire positioned in the first chamber and a ground wire positioned in the second chamber,
wherein:
turning the first screw causes the first terminal plate to compress the live wire into the first plate portion, and
turning the second screw causes the second terminal plate to compress the ground wire into the second plate portion.

10. The electrical connector of claim 9, wherein:
the first chamber is shaped to prevent lateral and rotational movement of the first terminal plate relative to a first axis defined by the first screw, and
the second chamber is shaped to prevent lateral and rotational movement of the second terminal plate relative to a second axis defined by the second screw.

11. The electrical connector of claim 9, further comprising a connector shell shaped to fit about the first end and to prevent access to the first and second screws.

12. The electrical connector of claim 11, wherein the connector shell further comprises:
an opening configured to receive the cable; and
a clamp disposed about the opening.

13. The electrical connector of claim 12, wherein the clamp comprises:
an upper clamp portion having a first upper passageway and a second upper passageway;
a lower clamp portion having a first lower passageway and a second lower passageway;
a first spacer positioned between the upper clamp portion and the lower clamp portion, the first spacer having a first spacer passageway aligned with the first upper passageway and the first lower passageway;
a second spacer positioned between the upper clamp portion and the lower clamp portion, the second spacer comprising a second spacer passageway aligned with the second upper passageway and the second lower passageway;
a first clamp screw received by the first spacer passageway, the first upper passageway, and the first lower passageway; and
a second clamp screw received by the second spacer passageway, the second upper passageway, and the second lower passageway,
wherein turning each of the first clamp screw and the second clamp screw causes the upper clamp portion and the lower clamp portion to move towards the first spacer and towards the second spacer and to compress the cable.

14. The electrical connector of claim 13, wherein the first spacer and the second spacer are monolithically formed with the connector shell.

15. A method for assembling a connector assembly, the method comprising:
providing a connector, the connector comprising:
a contact comprising:
a plate portion comprising a contact hole; and
a contact portion extending from the plate portion;
an inner housing defining a slot shaped to receive the plate portion and to hold the contact in a substantially fixed position; and
a terminal plate movably positioned within the inner housing, the terminal plate comprising:
a terminal surface; and
a threaded hole; and
inserting a threaded member through the contact hole to interface with the threaded hole;
inserting the wire into the inner housing between the plate portion and the terminal surface; and
turning an exposed end of the threaded member to cause the terminal surface to compress the wire onto the plate portion.

16. The method of claim 15, wherein the connector further comprises a connector shell shaped to fit about the inner housing and prevent access to the threaded member.

17. The method of claim 16, further comprising coupling the connector shell to the inner housing with a second threaded member.

18. The method of claim 16, wherein the connector further comprises a clamp, the clamp comprising:
an opening shaped to provide access to the inner housing for the wire;
an upper clamp portion defining an upper side of the opening;
a lower clamp portion defining a lower side of the opening;
a first spacer positioned between the upper clamp portion and the lower clamp portion, the first spacer defining a left side of the opening; and
a second spacer positioned between the upper clamp portion and the lower clamp portion, the second spacer defining a right side of the opening,
wherein the method further comprises:
inserting a first clamp threaded member into the upper clamp portion, the first spacer, and the lower clamp portion,
inserting a second clamp threaded member into the upper clamp portion, the second spacer, and the lower clamp portion, and
causing the upper and lower clamp portions to compress the wire by turning each of the first clamp threaded member and the second clamp threaded portion.

19. The method of claim 18, wherein the first spacer and the second spacer are monolithically formed with the connector shell.

20. The method of claim 15, wherein the inner housing is further shaped to prevent lateral and rotational movement of the terminal plate relative to an axis defined by the threaded member.
